(19) United States
(12) Patent Application Publication
(10) Pub. No.: US 2020/0269784 A1
(43) Pub. Date: Aug. 27, 2020

(54) INDUCTIVE POWER COUPLER FOR A VEHICLE SEAT AND VEHICLE SEAT

(71) Applicant: ADIENT ENGINEERING AND IP GMBH, BURSCHEID (DE)

(72) Inventor: ERIC BERNARD MICHALAK, CANTON, MI (US)

(73) Assignee: ADIENT ENGINEERING AND IP GMBH, BURSCHEID (DE)

(21) Appl. No.: 16/762,974

(22) PCT Filed: Oct. 24, 2018
(86) PCT No.: PCT/EP2018/079166

§ 371 Date: May 11, 2020

Related U.S. Application Data
(60) Provisional application No. 62/595,101, filed on Dec. 6, 2017.

(51) Int. Cl. B60R 16/03; B60L 53/122; B60N 2/02; B60N 2/06; B60N 2/14; H02J 50/10; H02J 50/40

(52) U.S. Cl. CPC B60R 16/03; B60L 53/122; B60N 2/0232; B60N 2/062; B60N 2/14; H02J 50/10; B60N 2002/0236; B60N 2/0244; B60N 2002/0212; B60N 2002/0264; B60N 2002/0216; B60N 2002/022; H02J 50/40

(57) ABSTRACT

The present disclosure relates to an inductive power coupler adapted to supply at least one electrical consumer attached to a vehicle seat in a vehicle. The inductive power coupler may have a transmitter with at least one transmitter coil that is electrically connected with a power source via a power line attached to a floor of the vehicle. The inductive power coupler may also have a receiver with at least one receiver coil, that is electrically connected with the at least one electrical consumer. The receiver is attached to the seat and at least one transmitter coil is inductively coupled to at least one receiver coil.

### BACKGROUND OF THE DISCLOSURE

The present disclosure relates generally to an inductive power coupler adapted to electrically power a vehicle seat and a vehicle seat comprising an inductive power coupler.

Vehicle seats according to the state of the art may comprise electrically powered components such as a motor or a heating. From the state of the art it is known to supply components that are in fixed relation to a vehicle seat with electrical energy by means of a wire harness to a power supply that is in fixed relation to the floor of the vehicle. Thereby, electrical power is continuously supplied to the seat irrespective of its movement relative to the vehicle such as a translation along a longitudinal axis extending from the back to the front of the vehicle or a rotation around a vertical direction extending from the floor to the roof of the vehicle.

According to the state of the art, a power supply wire harness is connected to the vehicle seat by a plug connector. Both the wire harness and the plug connector can be affected by faulty connections that result in a failure of the electrically powered components of the vehicle seat.

### SUMMARY OF THE DISCLOSURE

It is an object of the present disclosure to provide an improved power transmission for a vehicle seat, that in particularity is more robust and/or more reliable and/or more easy to assemble.

It is a further object of the present disclosure to provide a vehicle seat with an improved power transmission.

According to the disclosure, the object is solved by the features claimed in claim 1 or claim 11.

According to an aspect of the present disclosure, an inductive power coupler is adapted to electrically supply at least one electrical consumer mechanically integrated with a vehicle seat from a power source. The seat is mounted on a floor of the vehicle. The inductive power coupler is connected with the power source by a power line which is attached to the vehicle, for example attached to the floor, whereas the seat may be movable relative to the vehicle, for example translatable or rotatable relative to the floor of the vehicle.

According to an aspect of the present disclosure, a vehicle seat with such an inductive power coupler is provided.

The inductive power coupler comprises a receiver with at least one receiver coil that is electrically connected with the at least one electrical consumer and a transmitter with at least one transmitter coil that is electrically connected with the power source via the power line.

The receiver is mechanically integrated with the seat, wherein at least one transmitter coil is inductively coupled to at least one receiver coil. Thereby, the at least one transmitter coil and the at least one receiver coil form a transformer by which electrical energy is transmittable from the power source on the vehicle floor to the electrical consumer integrated with the vehicle seat.

As an advantage, electrical consumers in the vehicle seat can be supplied with electrical power without the need of a connector like a plug and a wire harness arranged between the vehicle seat and the floor. Thereby, a more reliable and robust electrical connection and a lower failure rate in the assembly of a vehicle can be reached.

As an example, an electrical consumer may be formed as a motor that moves the seat or a part thereof, such as lumbar motor. The electrical consumers may also be formed as a heating integrated into the seat.

In an exemplary embodiment the transmitter may comprise a DC/AC converter and the receiver may comprise an AC/DC converter, wherein the power source is formed as a vehicle battery. In this embodiment, a DC input of the DC/AC converter is connected with the vehicle battery and the AC output of the DC/AC converter is connected with the at least one transmitter coil. Further, the AC input of the AC/DC converter is connected with the at least one receiver coil and the DC output of the AC/DC converter is connected with the at least one electrical consumer.

As an advantage, this embodiment can particularly easily be integrated with DC vehicle batteries and DC electrical consumers in vehicle seats known from the state of the art.

In an exemplary embodiment, the receiver coil and/or the transmitter coil may be formed as a flat spiral coil. Flat spiral coils allow for a particularly flat design of an inductive power coupler that fits between the underneath of a vehicle seat and a vehicle floor.

In an exemplary embodiment, the transmitter is attached to the floor of the vehicle underneath a vehicle seat. With this embodiment, a particularly high efficiency of the power transmission over the inductive power coupler can be reached.

In an exemplary embodiment with a vehicle seat movable along a longitudinal direction, a plurality of transmitter coils are attached on the floor along the longitudinal direction underneath the seat. As an advantage, electrical consumers in the seat can be reliably supplied with electrical power independently of the longitudinal displacement of the seat, even if the seat is moving. As a further advantage, no electrical connectors are moved when the seat translates longitudinally. Thereby, the robustness and reliability of the supply of the seats electrical components with power is improved.

In an exemplary embodiment with a vehicle seat rotatable around a vertical rotational axis, at least one transmitter coil and at least one receiver coil are inductively coupled and aligned along the vertical rotational axis. As an advantage, electrical consumers in the seat can be reliably supplied with electrical power independently of the rotation of the seat, even if the seat is rotating. As a further advantage, no electrical connectors are moved when the seat rotates. Thereby, the robustness and reliability of the supply of the seat's electrical components with power is improved.

In another embodiment multiple transmitter coils are attached to the vehicle floor in the longitudinal as well as lateral direction, such that the seat can be reliably supplied with electrical power and move in any direction on the vehicle floor horizontally along the vehicle floor or rotates along a vertical axis. The lateral direction is defined as being perpendicular to the longitudinal direction and to the vertical axis.

According to this embodiment, at least one floor sensor is provided, wherein each floor sensor is designed to determine the proximity of the receiver coil on the seat to one of the transmitter coils on the vehicle floor such that the receiver coil and the respective transmitter coil remain or get inductively coupled as the seat moves along the floor. As a result, the occupant can move anywhere within the vehicle environment while maintaining power to the seat without any physical connections with vehicle floor. This is especially useful for autonomous vehicles that allow higher flexibility in the interior space.

In an exemplary embodiment, the plurality of transmitter coils are arranged in a grid that extends along the longitudinal and along the lateral direction. In another exemplary embodiment, the plurality of transmitter coils are arranged to form zones.

In an exemplary embodiment, the transmitter is attached to the seat, wherein the at least one transmitter coil is inductively coupled to the at least one receiver coil by a ferromagnet. As an advantage, a particularly high efficiency of the power transmission via the inductive power coupler is reached.

Any of the above described features may be combined with any other one or any plurality of the other ones.

### BRIEF DESCRIPTION OF THE DRAWINGS

The present disclosure will become more fully understood from the detailed description given herein below and the accompanying drawings which are given by way of illustration only, and thus, are not limitative of the present disclosure, wherein:

FIG. 1 shows a schematic longitudinal section through a vehicle seat with an inductive power coupler,

FIG. 2 shows a schematic perspective view on a vehicle seat with an inductive power coupler,

FIG. 3 shows a schematic perspective view on a rotatable vehicle seat with an inductive power coupler,

FIG. 4 shows a schematic circuitry of an inductive power coupler and

FIGS. 5A, 5B show views on inductive power coupler a vehicle seat with ferromagnetically supported mutual inductance.

Corresponding parts are marked with the same reference symbols in all figures.

### DETAILED DESCRIPTION OF PREFERRED EMBODIMENTS

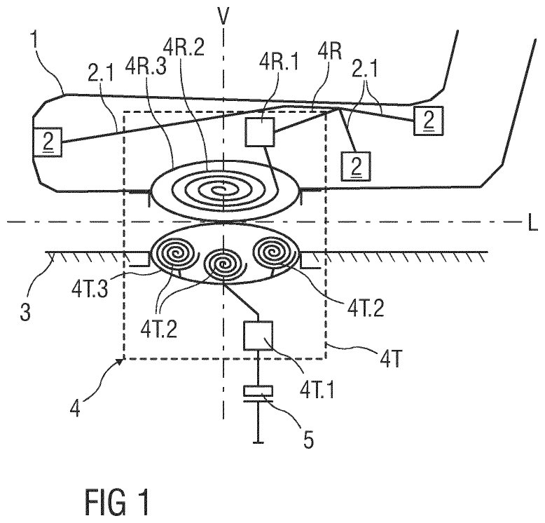

FIG. 1 shows a longitudinal section through a vehicle seat 1 with integrated electrically operated motors 2. The vehicle seat 1 is arranged above the floor 3 of the vehicle. The vehicle seat 1 may be formed translatable along a longitudinal axis L that extends from the back towards the front of the vehicle.

The motors 2 are powered via wires 2.1 embedded into the fabric of the vehicle seat 1 or a cushion thereof. The wires 2.1 may be printed onto the fabric by three-dimensional (3D)-print procedure. A wire 2.1 connects one or more motors 2 with an inductive power coupler 4, thereby powering the one or more motors 2.

The inductive power coupler 4 comprises a receiver 4R that is fixated relative to the vehicle seat 1 yet movable relative to the floor 3. The inductive power coupler 4 further comprises a transmitter 4T that is fixated relative to the floor 3 yet movable relative to the vehicle seat 1.

The transmitter 4T is formed to transform electrical energy, in particularity electrical energy provided by a vehicle battery 5, into an oscillating magnetic field.

The receiver 4R is formed to transform an oscillating magnetic field into electrical power, in particularity into directed current (DC) driving the motors 2.

The transmitter 4T comprises a DC/AC converter 4T.1 adapted to transform a DC voltage into an alternating current (AC) voltage. The input of the DC/AC converter 4T.1 is connected with the vehicle battery 5. The alternating voltage at the output of the DC/AC converter 4T.1 drives at least one transmitter coil 4T.2 arranged in a coil mount 4T.3. The at least one transmitter coil 4T.2 transforms the AC voltage provided by the DC/AC converter 4T.1 into an oscillating magnetic field that extends along a vertical axis V perpendicular to the floor 3.

The receiver 4R comprises at least one receiver coil 4R.2 arranged in a coil mount 4R.3 and adapted to transform an oscillating magnetic field along the vertical axis V into an AC voltage. The at least one receiver coil 4R.2 is connected to an AC/DC converter that transforms the AC voltage into a DC voltage usable for powering the at least one motor 2.

Thereby, with a sufficiently large mutual inductance between the at least one transmitter coil 4T.2 and the at least one receiver coil 4R.2, a transmission efficiency of at least 70 percent can be reached with an air gap of about 50 millimeters between the transmitter coil 4T.2 and the receiver coil 4R.2, wherein the transmission efficiency denotes which proportion of the electrical energy supplying the transmitter 4T is available at the output of the receiver 4R.

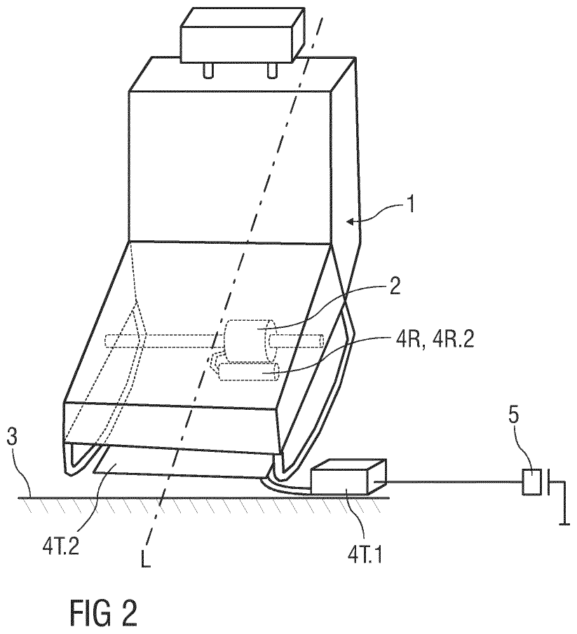

FIG. 2 shows a perspective view on a vehicle seat 1 with an integrated motor 2 powered by a receiver 4R. The transmitter coil 4T.2 extends underneath the seat cushion of the vehicle seat 1, such that it entirely covers the oppositely arranged receiver coil 4R.2 in any position that the seat 1 is translatable to along the longitudinal axis L. The DC/AC converter 4T.1 is arranged beside the vehicle seat 1.

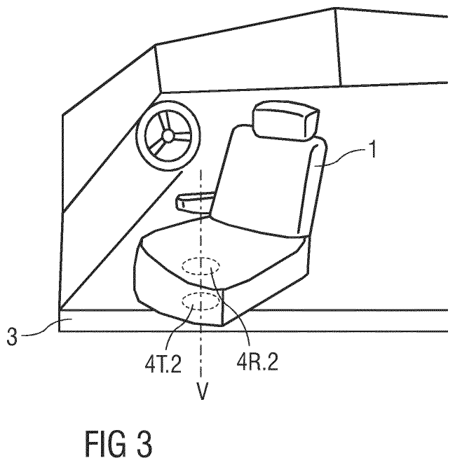

FIG. 3 shows a perspective view on an embodiment of the disclosure with an inductive power coupler 4 adapted to a seat 1 in a vehicle 9. The vehicle seat 1 is rotatable around a vertical rotational axis V. A transmitter coil 4T.2 and a receiver coil 4R.2 are arranged oppositely along the vertical axis V such that the mutual inductivity between the coils 4T.2, 4R.2 is unchanged upon a rotation of the seat 1.

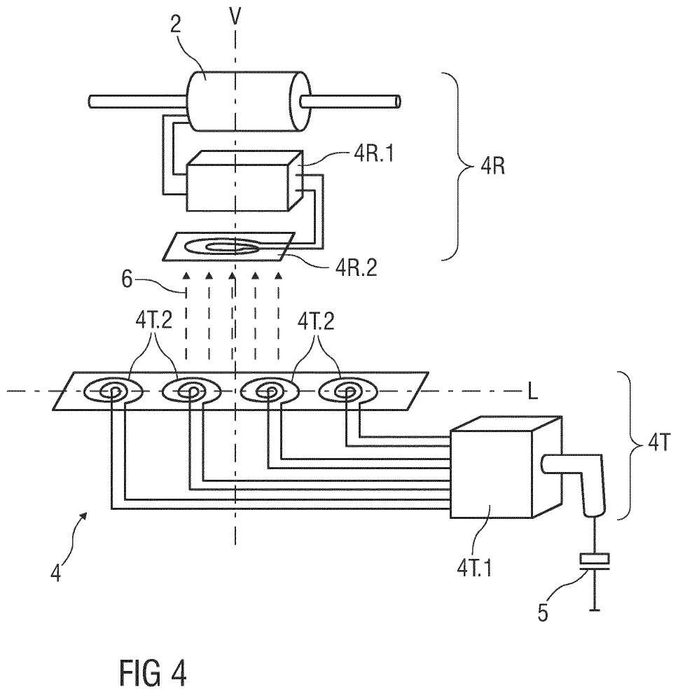

FIG. 4 shows a schematic circuitry of an inductive power coupler 4 with a transmitter 4T and a receiver 4R. The transmitter 4T comprises a plurality of transmitter coils 4T.2 that are linearly, equidistantly arranged along the longitudinal axis L such that the magnetic flux induced by a transmitter coil 4T.2 is substantially parallel to the magnetic flux induced by the other transmitter coils 4T.2 and to the vertical axis V. Each of the transmitter coils 4T.2 is powered independently of the others by the DC/AC converter 4T.1.

The receiver 4R comprises a single receiver coil 4R.2. The extensions of the receiver coil 4R.2 are chosen such that it covers one or more, but not all of the oppositely arranged transmitter coils 4T.2. Thereby, the magnetic flux 6 reaching the receiver coil 4T.2 remains substantially constant irrespective of its position along the longitudinal axis L.

The receiver coil 4R.2 and the transmitter coils 4T.2 are formed as flat spiral coils arranged on a foil or board. Such an embodiment allows for a design that can easily be integrated into vehicle seats as known from the state of the art. By way of example, the coils 4R.2, 4T.2 may be printed onto the foil or board.

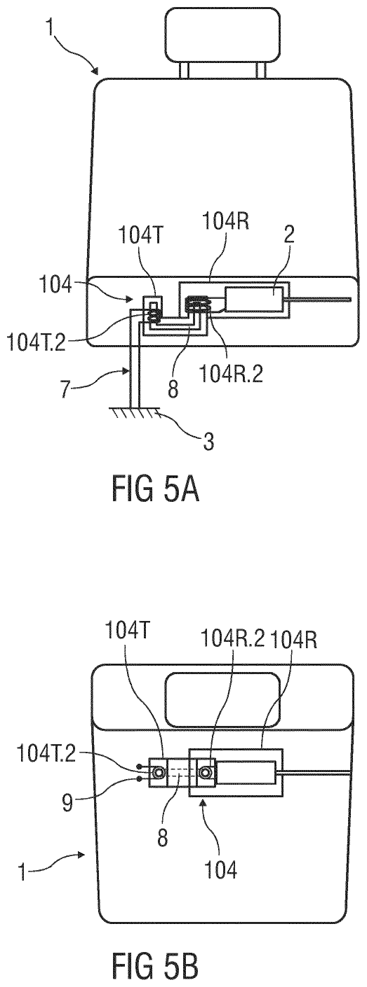

FIG. 5A shows a schematic front view on an embodiment of an inductive power coupler 104 comprising a transmitter stand 104T and a receiver box 104R which are mechanically coupled to each other and to the vehicle seat 1.

The transmitter stand 104T comprises a transmitter coil 104T.2 that is connected with and supplied by a power line 7. The power line 7 may be formed as a flexible wire harness that connects the transmitter coil 104T with a vehicle battery 5 not shown here.

The receiver box 104R comprises a receiver coil 104R.2 that is connected with a motor 2. The coils 104T.2, 104R2 are inductively coupled by a ferromagnet 8 with a relative magnetic permeability greater than 100, preferably greater than 1000. The ferromagnet 8 is U-shaped with one leg arranged in the transmitter coil 104T.2 and the opposing leg arranged in the receiver coil 104R.2. The coils 104T.2, 104R and the ferromagnet 8 thus form a transformer adapted to transfer an AC voltage from the power line 7 towards the motor 2. As an advantage, no mechanical or electrical connectors are required in order to supply the motor 2 with power from the power line 7.

FIG. 5B shows a schematic top view on the same embodiment as FIG. 5A. The U-shaped ferromagnet 8 has a circular cross section and is mounted into a stand for improved mechanical stability.

### LIST OF REFERENCES

1 vehicle seat

2 motor

2.1 wire

3 floor

4, 104 inductive power coupler

4R receiver

4R.1 AC/DC converter

4R.2 receiver coil

4R.3 coil mount

4T transmitter

4T.1 DC/AC converter

4T.2 transmitter coil

4T.3 coil mount

5 vehicle battery

6 magnetic flux

7 power line

8 ferromagnet

9 vehicle

104T transmitter stand

104T.2 transmitter coil

104R receiver box

104R.2 receiver coil

L longitudinal axis

V vertical axis

1-22. (canceled)

23. An inductive power coupler adapted to supply at least one electrical consumer attached to a vehicle seat in a vehicle, wherein the inductive power coupler comprises:
a transmitter with at least one transmitter coil that is electrically connected with a power source via a power line attached to a floor of the vehicle,
a receiver with at least one receiver coil, that is electrically connected with the at least one electrical consumer,
wherein the receiver is attached to the seat and wherein at least one transmitter coil is inductively coupled to at least one receiver coil.

24. The inductive power coupler according to claim 23, wherein the power source is formed as a vehicle battery and wherein the transmitter comprises a DC/AC converter with a DC input connected to the vehicle battery and with the AC output connected to the at least one transmitter coil and wherein the receiver comprises an AC/DC converter with an AC input connected with the at least one receiver coil and with the DC output connected with the at least one electrical consumer.

25. The inductive power coupler according to claim 23, wherein the receiver coil and/or the transmitter coil are/is formed as a flat spiral coil.

26. The inductive power coupler according to claim 23, wherein the transmitter is attached to the floor of the vehicle.

27. The inductive power coupler according to claim 26, wherein the seat is movable along a longitudinal axis and wherein a plurality of transmitter coils are attached on the floor along the longitudinal axis underneath the vehicle seat.

28. The inductive power coupler according to claim 27, wherein the seat is movable along a lateral axis being perpendicular to the longitudinal axis and to a vertical rotational axis and wherein a plurality of transmitter coils are attached on the floor along the lateral axis underneath the vehicle seat and wherein at least one floor sensor is provided, wherein each floor sensor is designed to determine the proximity of the receiver coil on the seat to one of the transmitter coils on the vehicle floor such that the receiver coil and the respective transmitter coil are inductively coupled if the floor sensor indicates proximity.

29. The inductive power coupler according to claim 27, wherein the power source is formed as a vehicle battery and wherein the transmitter comprises a DC/AC converter with a DC input connected to the vehicle battery and with the AC output connected to the at least one transmitter coil and wherein the receiver comprises an AC/DC converter with an AC input connected with the at least one receiver coil and with the DC output connected with the at least one electrical consumer.

30. The inductive power coupler according to claim 26, wherein the vehicle seat is rotatable around a vertical rotational axis and wherein at least one transmitter coil and at least one receiver coil are inductively coupled and aligned along the vertical rotational axis.

31. The inductive power coupler according to claim 30, wherein the power source is formed as a vehicle battery and wherein the transmitter comprises a DC/AC converter with a DC input connected to the vehicle battery and with the AC output connected to the at least one transmitter coil and wherein the receiver comprises an AC/DC converter with an AC input connected with the at least one receiver coil and with the DC output connected with the at least one electrical consumer.

32. The inductive power coupler according to claim 23, wherein the transmitter is attached to the vehicle seat and wherein the at least one transmitter coil is inductively coupled to the at least one receiver coil by a ferromagnet.

33. The inductive power coupler according to claim 24, wherein the transmitter is attached to the vehicle seat and wherein the at least one transmitter coil is inductively coupled to the at least one receiver coil by a ferromagnet.

34. A vehicle seat comprising an inductive power coupler adapted to supply at least one electrical consumer attached to the vehicle seat, wherein the inductive power coupler comprises:
a transmitter with at least one transmitter coil that is electrically connected with a power source via a power line attached to a floor of the vehicle,
a receiver with at least one receiver coil, that is electrically connected with the at least one electrical consumer,
and wherein the receiver is attached to the seat and wherein at least one transmitter coil is inductively coupled to at least one receiver coil.

35. The vehicle seat according to claim 34, wherein the power source is formed as a vehicle battery and wherein the transmitter comprises a DC/AC converter with a DC input connected to the vehicle battery and with the AC output connected to the at least one transmitter coil and wherein the receiver comprises an AC/DC converter with an AC input connected with the at least one receiver coil and with the DC output connected with the at least one electrical consumer.

36. The vehicle seat according to claim 34, wherein the receiver coil and/or the transmitter coil is formed as a flat spiral coil.

37. The vehicle seat according to claim 34, wherein the transmitter is attached to the floor of the vehicle.

38. The vehicle seat according to claim 37, wherein the seat is movable along a longitudinal axis and wherein a plurality of transmitter coils are attached on the floor along the longitudinal axis underneath the vehicle seat.

39. The vehicle seat according to claim 38, wherein the seat is movable along a lateral axis being perpendicular to the longitudinal axis and to a vertical rotational axis and wherein a plurality of transmitter coils are attached on the floor along the lateral axis underneath the vehicle seat and wherein at least one floor sensor is provided, wherein each floor sensor is designed to determine the proximity of the receiver coil on the seat to one of the transmitter coils on the vehicle floor such that the receiver coil and the respective transmitter coil are inductively coupled if the floor sensor indicates proximity.

40. The vehicle seat according to claim 38, wherein the power source is formed as a vehicle battery and wherein the transmitter comprises a DC/AC converter with a DC input connected to the vehicle battery and with the AC output connected to the at least one transmitter coil and wherein the receiver comprises an AC/DC converter with an AC input connected with the at least one receiver coil and with the DC output connected with the at least one electrical consumer.

41. The vehicle seat according to claim 37, wherein the vehicle seat is rotatable around a vertical rotational axis and wherein at least one transmitter coil and at least one receiver coil are inductively coupled and aligned along the vertical rotational axis.

42. The vehicle seat according to claim 41, wherein the power source is formed as a vehicle battery and wherein the transmitter comprises a DC/AC converter with a DC input connected to the vehicle battery and with the AC output connected to the at least one transmitter coil and wherein the receiver comprises an AC/DC converter with an AC input connected with the at least one receiver coil and with the DC output connected with the at least one electrical consumer.

43. The vehicle seat according to claim 34, wherein the transmitter is attached to the vehicle seat and wherein the at least one transmitter coil is inductively coupled to the at least one receiver coil by a ferromagnet.

44. The vehicle seat according to claim 35, wherein the transmitter is attached to the vehicle seat and wherein the at least one transmitter coil is inductively coupled to the at least one receiver coil by a ferromagnet.
